(19) United States
(12) Patent Application Publication
(10) Pub. No.: US 2026/0171089 A1
(43) Pub. Date: Jun. 18, 2026

(54) METHOD AND APPARATUS FOR DETERMINING A CONTROL TARGET OF A VOICE COMMAND

(71) Applicants: HYUNDAI MOTOR COMPANY, Seoul (KR); KIA CORPORATION, Seoul (KR)

(72) Inventor: Seong Soo Yae, Hwaseong-si (KR)

(73) Assignees: HYUNDAI MOTOR COMPANY, Seoul (KR); KIA CORPORATION, Seoul (KR)

(21) Appl. No.: 19/246,215

(22) Filed: Jun. 23, 2025

(30) Foreign Application Priority Data
Dec. 18, 2024 (KR) 10-2024-0189630

(51) Int. Cl. G10L 15/22

(52) U.S. Cl. CPC G10L 15/22; G10L 2015/223; G10L 2015/228

(57) ABSTRACT

A method and apparatus determine a control target of a voice command. A method for determining a control target of a voice command includes receiving an utterance of a user as a voice command. The method further includes determining the control target of the voice command among controllable devices based on utterance history and based on the voice command corresponding to a duplicate command for the controllable devices. The controllable devices may include a first device and a second device.

### CROSS-REFERENCE TO RELATED APPLICATION

This application claims the benefit of and priority to Korean Patent Application No. 10-2024-0189630, filed in the Korean Intellectual Property Office on Dec. 18, 2024, the entire disclosure of which is incorporated herein in its entirety by reference.

### TECHNICAL FIELD

The present disclosure relates to a method and apparatus for determining a control target of a voice command.

### SUMMARY

Therefore, there is a need to improve a method and apparatus for determining a control target when voice commands are duplicated based on a user's utterance history.

An objective of the disclosed embodiments is to provide a method and apparatus for determining a control target, e.g., a controllable target hardware device or component, of a voice command, which enables accurate determination of the control target when voice commands overlap between devices connected to a vehicle, thereby allowing control of the device that aligns with a user's intention.

The disclosed embodiments also provide a method and apparatus for determining a control target of a voice command, which enhances compatibility between devices connected to a vehicle by determining the target to be controlled by a user's voice command, which is a duplicate command.

The disclosed embodiments further provide a method and apparatus for determining a control target of a voice command, which enhances user convenience by automatically determining the control target of the voice command when a user's voice command is a duplicate command.

The disclosed embodiments also provide a method and apparatus for determining a control target of a voice command, which enhances the practicality and expandability of the voice command control method and apparatus by resolving the problem of overlapping voice commands.

The objectives to be achieved by the present disclosure are not limited to the objectives described above, and other objectives not explicitly mentioned should be apparent to those of ordinary skill in the art from the following description.

According to an aspect of the present disclosure, there is provided a method for determining a control target of a voice command. The method comprises receiving an utterance of a user as a voice command. The method further comprises determining the control target of the voice command among controllable devices based on utterance history and based on the voice command being a duplicate command for the controllable devices.

According to another aspect of the present disclosure, there is provided an apparatus for determining a control target of a voice command. The apparatus comprises a memory configured to store computer-executable instructions. The apparatus further comprises at least one processor configured to execute the computer-executable instructions to receive an utterance of a user as a voice command. The at least one processor is further configured to determine the control target of the voice command among controllable devices based on utterance history and based on the voice command being a duplicate command for the controllable devices.

An embodiment of the present disclosure enables accurate determination of a control target when voice commands overlap between devices connected to a vehicle, thereby allowing control of the device that aligns with a user's intention.

An embodiment of the present disclosure enhances compatibility between devices connected to a vehicle by determining a target to be controlled by a user's voice command, which is a duplicate command.

An embodiment of the present disclosure enhances user convenience by automatically determining the control target of a voice command based on the voice command being a duplicate command.

An embodiment of the present disclosure enhances the practicality and expandability of a voice command control method and apparatus by resolving the problem of overlapping voice commands.

The effects of the present disclosure are not limited to the above-mentioned effects. Other effects not mentioned should be clearly understood by those of ordinary skill in the art from the description below.

### BRIEF DESCRIPTION OF THE DRAWINGS

FIG. 1 is a diagram illustrating a situation in which a method according to an embodiment of the present disclosure is applied.

FIG. 2 is a functional block diagram of an apparatus for determining a control target of a voice command according to an embodiment of the present disclosure.

FIG. 3 is a flowchart illustrating a method for determining a control target of a voice command according to an embodiment of the present disclosure.

FIG. 4 is a flowchart illustrating a method for determining a control target of a voice command according to an embodiment of the present disclosure.

FIG. 5 is a flowchart illustrating a method for automatically setting a sub command of a device according to an embodiment of the present disclosure.

FIG. 6 is an example diagram illustrating a method for determining a control target of a voice command according to an embodiment of the present disclosure.

FIG. 7 is a schematic diagram of an illustrative configuration of a computing device that may be used to implement the apparatuses and methods described herein.

### DETAILED DESCRIPTION

Hereinafter, various embodiments of the present disclosure are described in detail with reference to the accompanying drawings. In the following drawings, the same reference numerals are used throughout to designate the same or equivalent elements, even though the elements are shown in different drawings. Further, in the following description of various embodiments, a detailed description of well-known functions and configurations incorporated therein has been omitted for the purpose of clarity and for brevity.

Additionally, various terms such as first, second, A, B, (a), (b), and the like, are used solely to differentiate one component from the other but not to imply or suggest the type, order, or sequence of the components. Throughout this specification, when a part ‘includes’ or ‘comprises’ a component, it is understood that the part may include other components, unless specifically stated otherwise. When a component, device, element, part, unit, module or the like of the present disclosure is described as having a purpose or performing an operation, function, or the like, the component, device, or element should be considered herein as being “configured to” meet that purpose or to perform that operation or function. Each “part”, “unit”, “module”, “component”, “device”, “element”, and the like may separately embody or be included with a processor and a memory, such as a non-transitory computer readable media, as part of the apparatus.

The following detailed description, together with the accompanying drawings, is intended to describe various embodiments of the present disclosure and is not intended to to limit the scope of the present disclosure to the embodiments described herein.

In the present disclosure, a user's voice command and voice commands of first and second devices may include a control target name slot or an action command slot that may be controlled by the voice command.

In the present disclosure, a “slot” refers to a semantic unit extracted from a user's voice command, such as a control target name slot (e.g., “driver's seat,” “car seat heater”) or an action command slot (e.g., “turn on,” “increase temperature”).

Slot extraction may be performed by the system by analyzing the linguistic structure of the voice command. The voice command is first transcribed into text via a speech recognition module. The transcribed text may then be tokenized and parsed to identify noun phrases and verb phrases. These linguistic components may be analyzed using part-of-speech tagging and rule-based pattern matching, and subsequently matched against predefined voice command databases stored in non-transitory memory, including a first device voice command database, a second device voice command database, and a duplicate command database that stores command collisions across devices.

When a control target or action term is associated with multiple devices—for example, when the term “car seat” may refer to both a built-in seat and an external baby seat—the system may reference a user utterance history database to determine which device the user has previously controlled using the same expression. If the utterance history provides no clear indication, the system may prompt the user for clarification via a user interface or automatically assign a sub-command (e.g., a nickname or alias) to one of the devices to resolve the ambiguity. The resolved slot-to-device mappings may be stored and updated in memory to ensure consistency in future voice command processing.

Through this process, control target name slots and action command slots are semantically extracted and accurately mapped to the appropriate device, enabling the system to generate and transmit corresponding control signals to the identified device via a communication interface, such as a controller area network (CAN) bus or a wireless protocol module. This architecture enables precise and context-aware control of multiple devices using natural voice commands, even in environments where command vocabularies overlap.

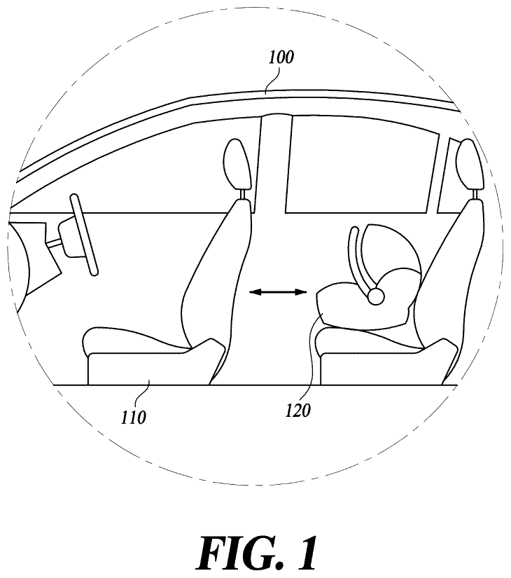

FIG. 1 is a diagram illustrating a situation in which a method according to an embodiment of the present disclosure is applied.

An apparatus for determining a control target of a voice command may be installed in a vehicle 100. The vehicle 100 may include controllable devices. The controllable devices may include hardware components/devices that may be controlled by the voice command. The controllable devices may include a first device 110, e.g., a first hardware component/device and a second device 120, e.g., a second hardware component/device. The vehicle may be connected to the second device 120 using wired or wireless communication.

The first device 110 may be a component/device that is built in the vehicle. For example, the first device 110 may be a driver's seat, a speaker, an air conditioner, and the like.

The second device 120 may be a component/device that may transmit and receive data using wired or wireless communication with the vehicle 100. For example, the second device 120 may include a baby seat, a mobile phone, a speaker, and the like. The wired or wireless communication may be wired communication, such as LAN (Local Area Network) communication or power line communication, or wireless communication, such as cellular communication, short-range wireless communication, or GNSS (Global Navigation Satellite System) communication. The short-range wireless communication may be Bluetooth, Wi-Fi direct, or IrDA (Infrared Data Association).

A user riding in the vehicle 100 may control the controllable devices including the first device 110 and the second device 120 by inputting a voice command to the apparatus for determining the control target of the voice command. There may be a case in which the target or action that may be controlled by the user's voice command includes both the first device 110 and the second device 120. The control target may include the controllable devices, e.g., both the first device 110 and the second device 120, or may refer to an action that is simultaneously applied to the controllable devices, e.g., both devices. A duplicate command refers to a voice command in which the control target of the voice command is duplicated or the target controlled by the action is duplicated.

If the user's voice command is a duplicate command in a state where the vehicle 100 is connected to the second device 120, there is a technical problem since it is difficult to determine the target, i.e., which one of the controllable devices, to be controlled using the voice command. A conventional voice recognition device of the vehicle 100 has the inconvenience that, when a duplicate command is given, only one of the controllable devices, e.g., the first device 110 or the second device 120, may be controlled, or the user must select the controllable device to be controlled every time. To solve such a technical problem, the present disclosure provides a method and device for automatically determining an object, i. e, which controllable hardware component/device is to be controlled by a duplicate command while a second device 120 is connected based on a user's utterance history.

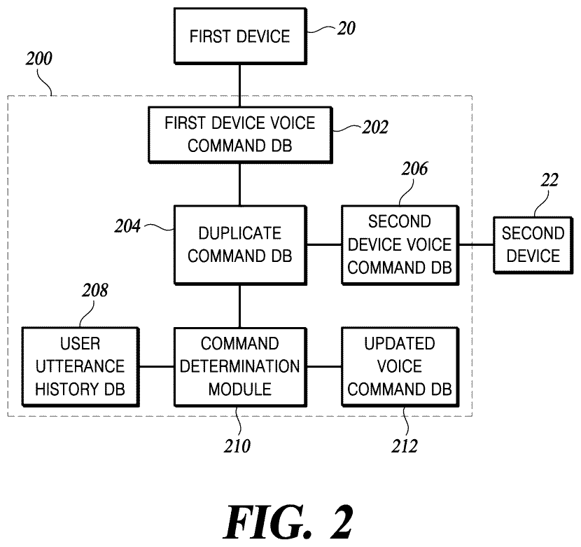

FIG. 2 is a functional block diagram of the apparatus for determining the control target of the voice command according to an embodiment of the present disclosure.

As shown in FIG. 2, the apparatus 200 for determining the control target of the voice command according to an embodiment of the present disclosure may include all or some of a first device voice command database (DB) 202, a duplicate command DB 204, a second device voice command DB 206, a user utterance history DB 208, a command determination module 210, and an updated voice command DB 212. The apparatus 200 may extract semantic units (slots) from the transcribed voice command by performing tokenization, part-of-speech tagging, and pattern matching. These slots may include control target name slots and action command slots and may be used to determine duplicate commands and control targets among the first and second devices.

The first device 20 may include the voice command DB for controlling the first device 20. The voice command DB included in the first device 20 may include main commands and sub commands for the first device 20. The main command and sub command for the first device 20 may be a voice command that is predefined. The main command for the first device 20 may be a voice command that is predefined to control the first device 20. The sub command for the first device 20 may be a predefined auxiliary command used to enhance recognition accuracy of the voice command. The sub command for the first device 20 may be a command that is set differently from the main command for the first device 20. For example, if the main command for the first device 20 is “driver's seat,” the sub command for the first device 20 may include nicknames or aliases such as “driver's seat,” “car seat,” or “seat.” In another example, if the main command for the first device 20 is “turn on a heated seat,” the sub command for the first device 20 may include other commands such as “driver's seat heater,” or “seat heater.” The main commands and sub commands may include a control target name slot or an action command slot that may be controlled based on the main command and sub command. The first device 20 may transmit the main commands and sub commands for the first device 20 using wired or wireless communication with the apparatus 200 for determining the control target of the voice command.

The second device 22 may include the voice command DB for controlling the second device 22. The voice command DB included in the second device 22 may include main commands and sub commands for the second device 22. The main command and sub command for the second device 22 may be a predefined voice command. The main command for the second device 22 may be a predefined voice command to control the second device 22. The sub command for the second device 22 may be a predefined auxiliary command used to enhance recognition accuracy of the voice command. The sub command for the second device 22 may be a command that is set differently from the main command for the second device 22. The second device 22 may transmit main commands and sub commands for the second device 22 using wired or wireless communication with the apparatus 200 for determining the control target of the voice command.

The apparatus 200 for determining the control target of the voice command may receive the main commands and sub commands of the first device 20 from the first device 20 using wired or wireless communication. The received main commands and sub commands of the first device 20 may be stored in the first device voice command DB 202. The apparatus 200 for determining the control target of the voice command may receive the main commands and sub commands of the second device 22 from the second device 22 using wired or wireless communication. The received main commands and sub commands of the second device 22 may be stored in the second device voice command DB 206.

The first device voice command DB 202 may be a database including the main commands and sub commands for the first device 20. The first device voice command DB 202 may store the main commands and sub commands of the first device 20, which are received via wired and/or wireless communication.

The duplicate command DB 204 may be a database in the form of a table that stores duplicate commands. The duplicate command may refer to a command in which the controllable target or action from the voice command may control both the first device 20 and the second device 22. The apparatus 200 for determining the control target of the voice command may determine whether a voice command is a duplicate command by checking whether any main command of the second device 22 overlaps with any main or sub command of the first device 20. Specifically, the apparatus 200 for determining the control target of the voice command may store identical commands in the duplicate command DB 204 depending on whether the control target name slots are identical or the action command slots are identical.

Whether it is the same control target name slot may be determined depending on whether the function controllable by the voice command is the same for both the first device 20 and the second device 22. For example, “driver's seat heater” may include two components: “driver's seat” and “heater.” “Driver's seat” refers to the seat location, while “heater” indicates the heating function. Another expression, such as “seat heater for driver's seat” may consist of three functional terms: “driver's seat,” “seat,” and “heater.” Here, “driver's seat” refers to the position, “seat” to the component, and “heater” to the function. Although the expressions “driver's seat heater” and “seat heater for driver's seat” are not completely identical in naming, they both indicate the same control function—controlling the heater of the driver's seat. Therefore, “driver's seat heater” and “seat heater for driver's seat” may be determined to belong to the same control target name slot.

Whether it is the same action command slot may be determined depending on whether the function controllable by the voice command is the same for both the first device 20 and the second device 22. For example, the action command slot “turn off the power” may perform the same function of turning off the device in both the first device 20 and the second device 22. Since the controllable function is the same, it may be determined as the same action command slot.

The second device voice command DB 206 may be a database including the main commands and sub commands for the second device 22. The second device voice command DB 206 may store main and sub commands for the second device 22 from the second device 22 via wired and wireless communication. When the vehicle 100 and the second device 22 are connected using wired or wireless communication such as Bluetooth, the vehicle 100 may receive main commands and sub commands for the second device 22 using a protocol. The vehicle 100 may interpret and process main commands and sub commands for the second device 22 according to the protocol rules and store them in the second device voice command DB 206.

The user utterance history DB 208 may store utterance history including voice commands through which the vehicle 100 has successfully controlled any of the controllable devices, e.g., the first device 20 or the second device 22, by receiving the user's voice command. The user utterance history DB 208 may include a list of control target name slots and action command slots of the voice command. It is possible to check whether the user has used the main command or the sub command for the first device 20 or the second device 22 using the user utterance history DB 208.

The command determination module 210 may determine the voice command that may control the first device 20 and the second device 22 based on the duplicate command DB 204 and the user utterance history DB 208. The command determination module 210 may store the determined voice commands in the updated voice command DB 212. A voice command stored in the user utterance history DB 208 may be a command that the user has previously used to control the first device 20 or the second device 22. Based on the user's language habits, the voice command in the user utterance history DB 208 may be determined as a command for controlling the first device 20 or the second device 22.

The command determination module 210 may determine whether any command included in the duplicate command DB 204 also appears in the user utterance history DB 208. If a voice command found in the user utterance history DB 208 also exists in the duplicate command DB 204, the command determination module 210 may determine the control target of the identical voice command to be the device associated with the command in the user utterance history DB 208.

In some cases, the voice command in the user utterance history DB 208 may correspond to the main command of the first device 20, and the main command of the first device 20 and the main command of the second device 22 are identical. The command in the duplicate command DB 204 may be a voice command that is common to the main command of the first device 20 and the main command of the second device 22. When the main command of the first device 20 is identical to the main command of the second device 22, the command determination module 210 may retain the main command of the first device 20 and determine that the control target associated with command is the first device 20. In such a case, the command determination module 210 may exclude the main command of the second device 22 from being used to control the second device 22. If a sub command for the second device 22 is available, the command determination module 210 may use it as the command for controlling the second device 22. If a sub command for the second device 22 is available, the command determination module 210 may use it as the command for controlling the second device 22. If no such sub command exists, a new sub command may be automatically assigned to the second device 22 such that it does not overlap with the main command of the first device 20.

For example, the first device 20 may be a driver's seat of the vehicle, and the second device 22 may be a baby seat. In this example, the main command for both the first device 20 and the second device 22 may be “car seat,” which serves as a duplicate command. If the user utterance history DB 208 includes a history of controlling the first device 20 with the command “car seat,” the command determination module 210 may determine the control target of the command “car seat” is the first device 20. The command determination module 210 may then exclude the main command “car seat” of the second device 22 from being used to control the second device 22. If a sub-command for the second device 22 is “baby seat,” the command determination module 210 may assign “baby seat” as the command for controlling the second device 22.

The user utterance history DB 208 may store both the main command and sub command of the first device 20, and in some cases, the main command and sub command of the first device 20 may be respectively identical to the main command and sub command of the second device 22. In this case, the commands stored in the duplicate command DB 204 may include commands extracted from the main and sub commands of both the first device 20 and the second device 22. The command determination module 210 may exclude the main and sub commands of the second device 22 from being used to control the second device 22. A new command may be automatically assigned to the second device 22 such that it does not overlap with the main or sub command of the first device 20.

In another case, the voice command stored in the user utterance history DB 208 may correspond to the sub command of the first device 20, while the main commands of both the first device 20 and second device 22 are identical. The command included in the duplicate command DB 204 may be a command extracted from the main command of the first device 20 and the main command of the second device 22. The command determination module 210 may exclude the main command of the first device 20 from being used to control the first device 20. The command determination module 210 may determine that the sub command of the first device 20 corresponds to a command for controlling the first device 20. The command determination module 210 may set the command capable of controlling the second device 22 as the main command of the second device 22.

For example, the first device 20 may be the driver's seat of the vehicle, and the second device 22 may be the baby seat. In this example, the sub command of the first device 20 and the main command of the second device 22 may both be “car seat.” The command “car seat” serves as a duplicate command, and the user utterance history DB 208 may include a history of controlling the first device 20 using the command “car seat.” The command determination module 210 may exclude the main command “car seat” of the first device 20 from being used to control the first device 20. The command determination module 210 may determine that the control target of the sub command “car seat” is the first device 20. The command determination module 210 may set the main command “car seat” for the second device 22 as the command capable of controlling the second device 22.

In some cases, the voice command included in the user utterance history DB 208 may be the main command of the first device 20, and the sub command of the first device 20 may be identical to the main command of the second device 22. The duplicate command DB 204 may include a command extracted from the sub command of the first device 20 and the main command of the second device 22. The command determination module 210 may exclude the sub command of the first device 20 from being used to control the first device 20. The command determination module 210 may determine that the control target of the main command of the first device 20 is the first device 20. The command determination module 210 may set a command capable of controlling the second device 22 as the main command of the second device 22.

In another case, the main command of the first device 20 and the main command of the second device 22 may be identical, while the user utterance history DB 208 does not include both the main command of the first device 20 and the main command of the second device 22. The duplicate command DB 204 may include a command extracted from the main commands of both the first device 20 and the second device 22. In the absence of a user utterance history, the command determination module 210 may determine the control target of the duplicate command based on the user's selection. If a sub command exists for the device not selected by the user, the command determination module 210 may designate that sub command as command for controlling the non-selected device. If no such sub command exists, the command determination module 210 may automatically assign the sub command of the non-selected device so as not to overlap with the main commands of the first device 20 and the second device 22.

For example, the first device 20 may be the driver's seat of the vehicle, and the second device 22 may be the baby seat. The main command for both the first device 20 and the second device 22 may be “car seat.” The command “car seat” is the duplicate command, and there may be no history of controlling the first device 20 with the command “car seat” in the user utterance history DB 208. The command determination module 210 may determine the control target of the “car seat” based on the user's selection. If the user selects the control target of the “car seat” as the first device 20, the command determination module 210 may exclude the main command “car seat” of the second device 22 from being used to control the second device 22. When the sub command for the second device 22 is “baby seat,” the command determination module 210 may set the command capable of controlling the second device 22 to “baby seat.” If there is no sub command for the second device 22, the command determination module 210 may automatically assign the sub command of the second device 22, such as “second car seat,” so as not to overlap with the main commands of the first device 20 and the second device 22.

The updated voice command DB 212 is a database in which the command determination module 210 updates voice commands that may control the first device 20 and the second device 22 based on the first device voice command DB 202 and the second device voice command DB 206. The updated voice command DB 212 may be a database in which the voice command for the first device 20 and the voice command capable of controlling the second device 22 are configured separately. The updated voice command DB 212 may be in the form of a user dictionary. For example, the updated voice command DB 212 may be a user dictionary in the form of key-value pairs, CSV (Comma-Separated Values), JSON (JavaScript Object Notation), text file, and XML (eXtensible Markup Language).

Not all blocks illustrated in FIG. 2 are essential components. Various blocks included in the apparatus 200 for determining the control target of the voice command may be added, changed, or deleted in other embodiments. The components illustrated in FIG. 2 represent functionally distinct elements, and at least one of the components may be implemented to be integrated with each other in an actual physical environment.

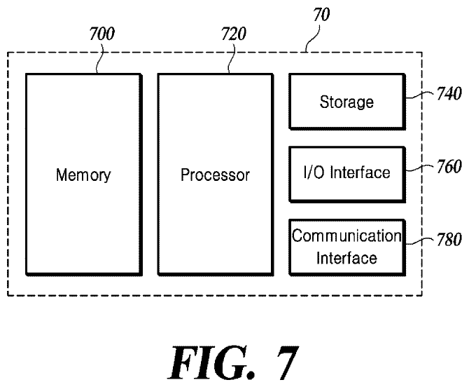

One of ordinary skill in the art should appreciate that one or more modules, e.g., the command determination module 210 or a speech recognition module described herein may be implemented using, among other things, a tangible computer-readable medium or non-transitory memory comprising computer-executable instructions (e.g., executable software code) executed by specifically configured hardware or processors, e.g., one or more processors 720 described in more detail with respect to FIG. 7. It should be appreciated that the disclosed embodiments may be implemented as a different or separate module of the apparatus 200, or a separate computer system coupled with the apparatus 200.

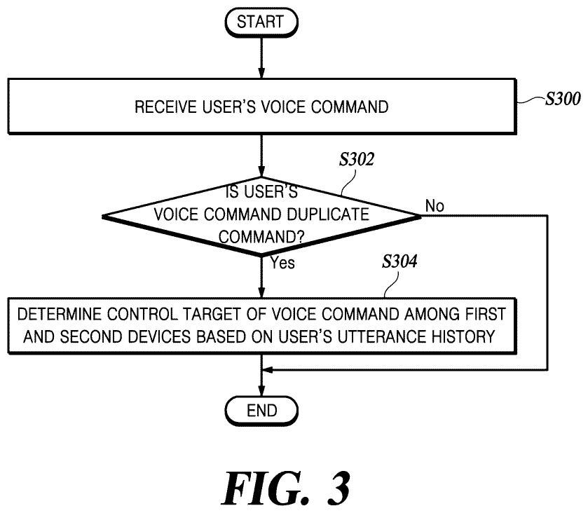

FIG. 3 is a flowchart illustrating a method for determining a control target of a voice command according to an embodiment of the present disclosure.

In step S300, the apparatus 200 for determining the control target of the voice command receives a user's utterance in the form of the voice command as input, e.g., an utterance or a voice command of the user. A microphone, e.g., a speech recognition microphone, that may be installed, for example, in a vehicle, may acquire or capture the input utterance, e.g., a user's utterance or voice command, and convert the input utterance to a speech signal. A speech recognition module (not shown) may receive the speech signal and transcribe and convert the speech signal representing the voice command from the microphone into a waveform of the voice command, text data of the voice command, or a plurality of words. In other words, the wave form, text data, or the plurality of words represent a transcription of the voice command into text.

In step S302, the apparatus 200 determines whether the user's voice command is a duplicate command. This determination may be based on whether the controllable target or action associated with the user's voice command can control both the first device 20 and the second device 22. In other words, the apparatus 200 may determine whether the voice command is included in the duplicate command DB 204. Step S302 may be implemented using a processor included in the apparatus 200, e.g., the processor 720 described in more detail with respect to FIG. 7.

In step S304, when the user's voice command is the duplicate command for the first device 20 and the second device 22 (Yes in S302), the apparatus 200 for determining the control target of the voice command determines the control target of the voice command based on the user utterance history DB 208. Specifically, the command determination module 210 may determine the control target of the voice command. Step S304 may be implemented using the processor included in the apparatus 200 for determining the control target of the voice command.

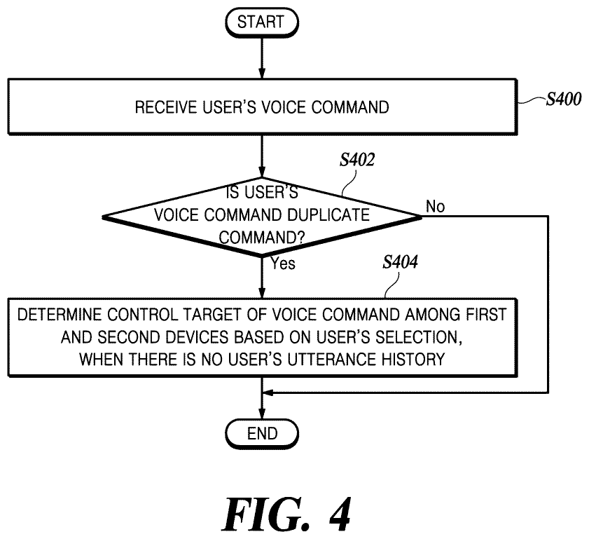

FIG. 4 is a flowchart illustrating a method for determining a control target of a voice command according to an embodiment of the present disclosure.

In step S400, the apparatus 200 for determining the control target of the voice command receives the user's utterance in the form of the voice command.

In step S402, the apparatus 200 for determining the control target of the voice command determines whether the user's voice command is the duplicate command. This determination may be based on whether the controllable target or action associated with the user's voice command can control both the first device 20 and the second device 22. In other words, the apparatus 200 may determine whether the voice command is included in the duplicate command DB 204. Step S402 may be implemented using a processor included in the apparatus 200 for determining the control target of the voice command, e.g., the processor 720 described in more detail with respect to FIG. 7.

In step S404, when the user's voice command is the duplicate command and there is no utterance history for the voice command in the user utterance history DB 208 (Yes in S402), the apparatus 200 for determining the control target of the voice command determines the control target of the voice command among the first device 20 and the second device 22 based on the user's selection. Specifically, the command determination module 210 may determine the control target of the voice command. Step S404 may be implemented using the processor included in the apparatus 200 for determining the control target of the voice command, e.g., the processor 720 described in more detail with respect to FIG. 7.

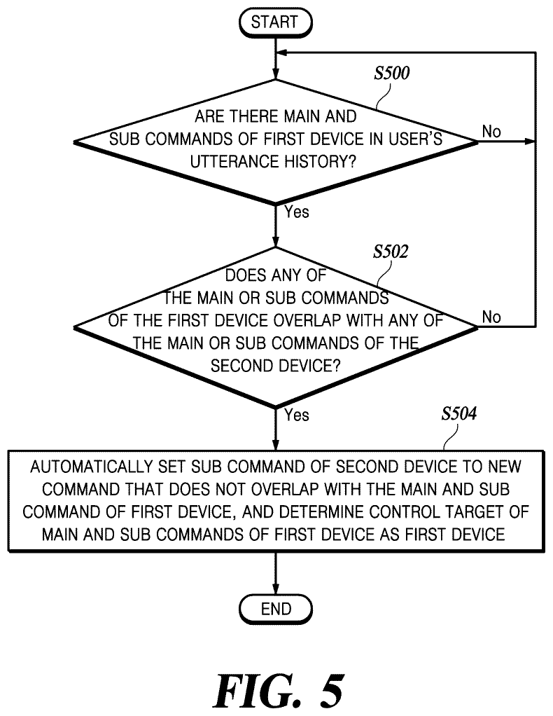

FIG. 5 is a flowchart illustrating a method for automatically setting the sub command of the second device according to an embodiment of the present disclosure.

In step S500, the apparatus 200 for determining the control target of the voice command determines whether the main command and the sub-command of the first device 20 are included in the user utterance history DB 208.

In step S502, the apparatus 200 for determining the control target of the voice command determines whether the main command and sub command of the second device 22 are identical to the main command and sub command of the first device 20, respectively. In other words, the apparatus 200 may determine whether commands extracted from the main commands and sub commands of both the first device 20 and the second device 22 are included in the duplicate command DB 204.

In step S504, when the user's utterance history includes both the main command and the sub command of the first device 20, and the main command and sub command of the second device 22 are identical to the main command and sub command of the first device 20 (Yes in S502), the apparatus 200 for determining the control target of the voice command automatically sets a new sub command for the second device 22 such that it does not overlap with the main and sub commands of the first device 20. The apparatus 200 then determines that the control target of the main and sub commands of the first device 20 is the first device 20.

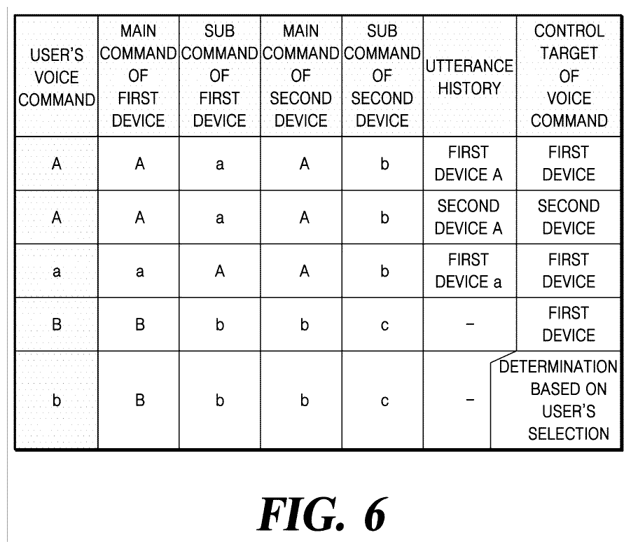

FIG. 6 is an example diagram illustrating a method for determining a control target of a voice command according to an embodiment of the present disclosure.

As a first example, there may be a case where the user's voice command is “A,” the sub command of the first device 20 is “a,” the sub command of the second device 22 is “b,” the voice command included in the user utterance history DB 208 is the main command “A” of the first device 20, and the main command “A” of the first device 20 is identical to the main command “A” of the second device 22. The command determination module 210 may maintain the main command “A” of the first device 20 included in the user utterance history DB 208 as the command that may control the first device 20. The command determination module 210 may exclude the main command “A” of the second device 22 from the commands that may control the second device 22. The command determination module 210 may set the command capable of controlling the second device 22 as the sub command “b” of the second device 22. The command determination module 210 may determine the target controlled by the user's voice command “A” as the first device 20.

As a second example, there may be a case where the user's voice command is “A,” the sub command of the first device 20 is “a,” the sub command of the second device 22 is “b,” the voice command included in the user utterance history DB 208 is the main command “A” of the second device 22, and the main command “A” of the first device 20 is identical to the main command “A” of the second device 22. The command determination module 210 may maintain the main command “A” of the second device 22 included in the user utterance history DB 208 as the command that may control the second device 22. The command determination module 210 may exclude the main command “A” of the first device 20 from the commands that may control the first device 20. The command determination module 210 may set the command capable of controlling the first device 20 as the sub command “a” of the first device 20. The command determination module 210 may determine the target controlled by the user's voice command “A” as the second device 22.

As a third example, there may be a case where the user's voice command is “a,” the main command of the first device 20 is “a,” the sub command of the second device 22 is “b,” the voice command included in the user utterance history DB 208 is the main command “a” of the first device 20, and the sub command “A” of the first device 20 is identical to the main command “A” of the second device 22. The command determination module 210 may maintain the main command “a” of the first device 20 included in the user utterance history DB 208 as the command that may control the first device 20. The command determination module 210 may exclude the sub command “A” of the first device 20 from the commands that may control the first device 20. The command determination module 210 may set the command capable of controlling the second device 22 as the sub command “b” of the second device 22. The command determination module 210 may determine the target controlled by the user's voice command “a” as the first device 20.

As a fourth example, there may be a case where the user's voice command is “B,” the main command of the first device 20 is “B,” the sub command of the second device 22 is “c,” the sub command “b” of the first device 20 is identical to the main command “b” of the second device 22, the user utterance history DB 208 does not include the main command “B” of the first device 20, the sub command “b” of the first device 20, the main command “b” of the second device 22, and the sub command “c” of the second device 22. The command determination module 210 may maintain the main command “B” of the first device 20 as the command that may control the first device 20. The command determination module 210 may exclude the sub command “b” of the first device 20 from the commands that may control the first device 20. The command determination module 210 may set the command capable of controlling the second device 22 as the main command “b” of the second device 22. The command determination module 210 may determine the target controlled by the user's voice command “B” as the first device 20.

As a fifth example, there may be a case where the user's voice command is “b,” the main command of the first device 20 is “B,” the sub command of the second device 22 is “c,” the sub command “b” of the first device 20 is identical to the main command “b” of the second device 22, the user utterance history DB 208 does not include the main command “B” of the first device 20, the sub command “b” of the first device 20, the main command “b” of the second device 22, and the sub command “c” of the second device 22. The command determination module 210 may determine the target controlled by the voice command based on the user's selection. If the user selects the target controlled by the voice command “b” as the first device 20, the command determination module 210 may maintain the sub command “b” of the first device 20 as the command that may control the first device 20. The command determination module 210 may exclude the main command “b” of the second device 22 from the commands that may control the second device 22. The command determination module 210 may set the command capable of controlling the second device 22 as the sub command “c” of the second device 22. The command determination module 210 may determine the target controlled by the user's voice command “b” as the first device 20.

FIG. 7 is a schematic diagram of an illustrative configuration of a computing device that may be used to implement the apparatuses and methods described herein.

The computing device 70 may include some or all of a non-transitory memory 700, a processor 720, a storage 740, an input and output (I/O) interface 760, and a communication interface 780. The computing device 70 may structurally and/or functionally include at least a portion of the apparatus 200 for determining the control target of the voice command. The computing device 70 may be a stationary computing device such as a desktop computer, a server, or an AI accelerator as well as a mobile computing device such as a laptop computer or a smart phone. The computing device 70 may include any specialized hardware accelerator capable of processing operations for an artificial intelligence model in an efficient manner. For example, the computing device 70 may include a graphic processing unit (GPU), a tensor processing unit (TPU), or a neural processing unit (NPU).

The memory 700 may store a program that allows the processor 720 to perform methods or operations according to various embodiments of the present disclosure. For example, the program may include a plurality of computer-executable instructions stored in the memory 700 executable by the processor 720. The above-described method(s) or operation(s) may be performed by the processor 720 executing the plurality of commands or computer-executable instructions. The first device voice command DB 202, the duplicate command DB 204, the second device voice command DB 206, the user utterance history DB 208, and the updated voice command DB 212 may be implemented using the memory 700. In particular, the first device voice command DB 202, the duplicate command DB 204, the second device voice command DB 206, the user utterance history DB 208 storing the utterance history, and the updated voice command DB 212 may be stored in the memory 700.

The memory 700 may be a single memory or multiple memories. In this case, information required to perform the method or operation according to various embodiments of the present disclosure may be stored in the single memory or divided and stored in the multiple memories. When the memory 700 is composed of multiple memories, the multiple memories may be physically separated.

The memory 700 may include at least one of volatile memory and non-volatile memory. The volatile memory includes SRAM (Static Random Access Memory) or DRAM (Dynamic Random Access Memory), and the nonvolatile memory includes flash memory.

The processor 720 may include at least one core capable of executing at least one command. The processor 720 may execute commands or computer-executable instructions stored in the memory 700. The processor 720 may be a single processor or multiple processors. The function of determining whether the voice command is the duplicate command and the function of the command determination module 210 may be implemented by the processor 720. Further, the function of controlling the controllable devices including the first device and the second device may be implemented by the processor 720 based on the voice command. In particular, the vehicle 100, the apparatus 200 or the processor 720 may be configured to control the controllable devices based on the voice command.

The storage 740 maintains stored data even when power supplied to the computing device 70 is cut off. For example, the storage 740 may include the non-volatile memory and may include storage media such as magnetic tape, optical disks, or magnetic disks.

A program stored in the storage 740 may be loaded into the memory 700 before being executed by the processor 720. The storage 740 may store source files written in a programming language, and a program compiled from the source files by a compiler or the like may be loaded into the memory 700. The storage 740 may store data to be processed by the processor 720 and/or data processed by the processor 720. The first device voice command DB 202, the duplicate command DB 204, the second device voice command DB 206, the user utterance history DB 208, and the updated voice command DB 212 may be implemented using the storage 740.

The input/output interface 760 may provide an interface with an input device such as a keyboard or a mouse, and/or an output device such as a display device or a printer. A user may trigger execution of a program by the processor 720 through the input device and/or check the processing result of the processor 720 through the output device. Steps S300 and S400 of receiving a user's utterance in the form of the voice command may be implemented using the input/output interface 760.

The communication interface 780 may provide access to an external network. For example, the computing device 70 may communicate with other devices via the communication interface 780. For instance, the other devices may include the first device 20 and the second device 22.

Each element of the apparatus or method in accordance with the present disclosure may be implemented in hardware or software, or a combination of hardware and software. The functions of the respective elements may be implemented in software. A microprocessor may be implemented to execute the software functions corresponding to the respective elements.

Various embodiments of systems and techniques described herein may be realized with digital electronic circuits, integrated circuits, field programmable gate arrays (FPGAs), application specific integrated circuits (ASICs), computer hardware, firmware, software, and/or combinations thereof. The various embodiments may include implementation with one or more computer programs that are executable on a programmable system. The programmable system includes at least one specifically configured programmable processor, which may be a special purpose or specifically configured processor coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data may be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code may be stored and executed in a distributive manner.

Although operations are illustrated in the flowcharts/timing charts in this specification as being sequentially performed, this is merely a description of the technical idea of one embodiment of the present disclosure. In other words, those of ordinary skill in the art to which various embodiments of the present disclosure belong may appreciate that various modifications and changes may be made without departing from essential features of an embodiment of the present disclosure. In other words, the sequence illustrated in the flowcharts/timing charts may be changed and one or more operations of the operations may be performed in parallel. Thus, flowcharts/timing charts are not limited to the temporal order.

Although various embodiments of the present disclosure have been described for illustrative purposes, those of ordinary skill in the art should appreciate that various modifications, additions, and substitutions are possible, without departing from the idea and scope of the claimed disclosure. Therefore, various embodiments of the present disclosure have been described for the sake of brevity and clarity. The scope of the technical idea of the present embodiments is not limited by the illustrations. Accordingly, one of ordinary skill in the art would understand that the scope of the claimed disclosure is not to be limited by the above explicitly described embodiments but by the claims and equivalents thereof.

What is claimed is:

1. A method for determining a control target of a voice command, the method comprising:
receiving an utterance of a user as a voice command; and
determining, based on utterance history, the control target of the voice command among controllable devices based on the voice command being a duplicate command for the controllable devices.

2. The method of claim 1, wherein determining the control target comprises:
determining, based on the voice command being the duplicate command and no corresponding utterance history being available, the control target of the voice command among the controllable devices based on a selection by the user.

3. The method of claim 1, wherein determining the control target comprises:
determining whether the voice command is the duplicate command, based on whether the voice command is associated with the controllable devices or an action that is common to the controllable devices.

4. The method of claim 1, wherein determining the control target comprises:
determining that one of the controllable devices controlled by the duplicate command stored in the utterance history is the control target of the voice command.

5. The method of claim 1,
wherein the controllable devices include a first device and a second device,
wherein, based on the utterance history including a main command and sub command of the first device and based on a main command and sub command of the second device being identical to the main command and the sub command of the first device, determining the control target comprises:
automatically setting the sub command of the second device to a new command that does not overlap with the sub command of the first device; and
determining the control target of the main command and sub command of the first device as the first device,
wherein the main and sub commands of the first and second devices are predefined voice commands.

6. The method of claim 1, wherein the utterance history is stored in a non-transitory memory and wherein the utterance history includes previous voice commands through which any of the controllable devices has been successfully controlled by receiving the voice command.

7. The method of claim 1, wherein the utterance history is stored in a non-transitory memory, and wherein the utterance history includes a list of control target name slots and action command slots of the voice command.

8. The method of claim 1, further comprising:
controlling the control target based on the voice command.

9. An apparatus for determining a control target of a voice command, the apparatus comprising:
a non-transitory memory configured to store computer-executable instructions; and
at least one processor configured to execute the computer-executable instructions to:
receive an utterance of a user as a voice command; and
determine, based on utterance history, the control target of the voice command among controllable devices based on the voice command being a duplicate command for the controllable devices.

10. The apparatus of claim 9, wherein, to determine the control target, the processor is further configured to:
determine, based on a selection by the user, the control target of the voice command among the controllable devices based on the voice command being the duplicate command and no corresponding utterance history being available.

11. The apparatus of claim 9, wherein, to determine the control target, the processor is further configured to:
determine whether the voice command is the duplicate command, based on whether the voice command is associated with the controllable devices or action that is common to the controllable devices.

12. The apparatus of claim 9, wherein, to determine the control target, the processor is further configured to:
determine that one of the controllable devices controlled by the duplicate command stored in the utterance history is the control target of the voice command.

13. The apparatus of claim 9,
wherein the controllable devices include a first device and a second device, and
wherein, based on the utterance history including a main command and sub command of the first device and based on a main command and sub command of the second device being identical to the main command and sub command of the first device, to determine the control target, the processor is further configured to:
automatically set the sub command of the second device to a new command that does not overlap with the sub command of the first device, and
determine the control target of the main command and the sub command of the first device as the first device, wherein the main and sub commands of the first and second devices are predefined voice commands.

14. The apparatus of claim 9,
wherein the utterance history is stored in a non-transitory memory, and
wherein the utterance history includes previous voice commands through which the processor has successfully controlled any of the controllable devices by receiving the voice command.

15. The apparatus of claim 9,
wherein the utterance history is stored in a memory, and
wherein the utterance history includes a list of control target name slots and action command slots of the voice command.

16. The apparatus of claim 9, wherein the processor is configured to control the control target based on the voice command.
